(19) United States
(12) Patent Application Publication
(10) Pub. No.: US 2001/0054073 A1
(43) Pub. Date: Dec. 20, 2001

(54) Method and system for handling E-mail messages in a communication system

(75) Inventors: Werner Ruppert, Schoenaich (DE); Gerhard Schneidt, Ammerbuch (DE)

Correspondence Address: Kevin P. Radigan, Esq., HESLIN & ROTHENBERG, P.C., 5 Columbia Circle, Albany, NY, 12203, US

(73) Assignee: International Business Machines Corporation, Armonk, NY (US)

(21) Appl. No.: 09/775,139

(22) Filed: Feb. 1, 2001

(30) Foreign Application Priority Data
Feb. 2, 2000 (EP) 00102323.3

(51) Int. Cl. G06F 15/16; G06F 15/173

(52) U.S. Cl. 709/206; 709/238

(57) ABSTRACT

The invention relates to a method and system for handling E-mail messages in a communication system. According to the present invention in a communication system comprising one or several intermediate receivers any attachment in an E-mail message is detached in the intermediate receiver and stored. Furthermore the attachment is replaced with a reference to the stored attachment before the E-mail message is forwarded to the recipient. With the use of the present invention the attachment of the E-mail stays always as close as possible to the receiver location. Changes to E-mail handling components on the sender's side and in the transmitting network are not necessary. Since storage and transmission of redundant data is suppressed, there are considerable savings of transmission cost, disk space, and mailing time.

### PRIOR FOREIGN APPLICATION

This application claims priority from European patent application number 00102323.3, filed Feb. 2, 2000, which is hereby incorporated herein by reference in its entirety.

### TECHNICAL FIELD

The invention relates to a method and system for handling E-mail messages in a communication system.

### BACKGROUND ART

An increasing number of E-mail systems support standards which allows the message body of the E-mail to contain ‘attachments’ of different kinds rather than just one block of plain ASCII text.

In simple E-mail systems the recipients retrieve their E-mail with such attachments from a mail server, whereby the total mail is deleted from that mail server and the attachment can be detached and stored on the recipients workstation. More sophisticated groupware systems like Lotus Notes (registered trademark) or Microsoft (registered trademark) Exchange store E-mails in server databases and allow the recipients to either work directly at the server or to replicate the server database to the recipients workstation and work from there. In cases where recipients work with replications of their mail databases, large attachments are often seen as impractical, since they are transferred to the recipient during replication. This is especially the case for recipients using mobile computer with a low-speed communication link to a mail server. Once the E-mail with attachment has reached the recipient, such systems allow the recipients to detach the attachments manually. After detaching, the original attachment is however still included in the E-mail. If the recipient does not want the attachment to be included in any reply, he has to removed the attachment from the E-mail manually.

In Lotus Notes it is further known to include links in Lotus Notes documents, e.g. E-mails. However, these links have to be created manually, and in contrary to attachments which can be any kind of file type, e.g. graphics, wordprocessor, multimedia file, refer only to Lotus Notes documents, which are located e.g. in Lotus Notes databases.

An E-mail system with attachment handling is described in U.S. Pat. No. 5,903,723. Therein attachments are not sent with the E-mail. Instead, an attachment reference is used. The reference points to the location of the attachment, which is as local as possible to the sender of the E-mail. Using this approach, transmission time is reduced for the sending server, if the receiver never attempts to read the attachment of the E-mail. This is in contradiction to the objective of the sender and does not meet the average E-mail analysis statistics, since the majority of the attachments will be opened at least once by each recipient. If further instances (e.g. ‘post offices’) remain to be traveled through by the E-mail before reaching a recipient, each subsequent post office may make further copies of the attachment and change the attachment reference as required to point to the latest storage location of the copy of the attachment, or may leave the attachment reference untouched as the case ordains. The overall cost of attachment file transport and storage is relatively high, assuming that the majority of the recipients read the attachment, since in this case additional processes have to be performed to go back all the way to the sender and fetch the attachment back again all the way. The time to read the attachments is so drastically increased for the recipient. The retrieval of an attachment in such a system can be quite complicated, if the attachment is stored on the sender's personal computer or in a post office at the sender's side. E.g. it can be difficult to ensure, that all recipients of the attached reference are allowed to access the attachments stored remotely at the senders's side.

### SUMMARY OF THE INVENTION

It is therefore an object of the present invention to provide a method and system for handling E-mail messages in a communication system.

This and other objects of the invention are achieved by a method and system according to the independent claims.

According to the present invention in a communication system comprising one or several intermediate receivers any attachment in an E-mail message is detached in the intermediate receiver and stored. Furthermore the attachment is replaced with a reference to the stored attachment before the E-mail message is forwarded to the recipient.

Furthermore a system for handling E-mail messages according to the decribed method is provided.

In a preferred embodiment of the present invention the attachments are detached by means of an attachment handling device and copied in a server attachment database accessable to all intermediate receivers at a receiving side, preferably on the intermediate server. Furthermore access conditions are defined such that the stored attachment is accessable for each recipient of the according reference. Thereby it is ensured, that all recipients of the attached reference are authorized to access their attachments. Upon an according request of the recipient, the stored attachment is transferred to the recipient.

In an E-mail system utilizing the present invention it is not necessary to store an attachment repeatedly for each recipient on the receiving server. For each attachment only one copy is stored to the server attachment database. The E-mails delivered to the recipients comprise only the reference. If an E-mail with attachment is sent to multiple recipients on the same receiving server, all recipients will receive an E-mail with a reference to the same attachment document copy. The performance of the attachment handling system can be further optimized if multiple receiving servers, located close to each other, share the same attachment database. In cases where recipients work with replications of their mail databases, they do not need to transfer attachments to their local mail databases during replication.

An E-mail system using the present invention can operate successfully even if the sending side does not know that an attachment handling system is implemented at the receiving side, since there are no requirements to the incoming E-mail. On the other hand, if a user of the E-mail system using the present invention sends an E-mail to a user of another E-mail system, there are no problems either since the attachment handling system operates only on the receiving side. In cases where a user of the E-mail system using the present invention replies to a received E-mail, which included an attachment (which has then been replaced by a reference), the outgoing E-mail preferably includes the reference only, indicating to the recipient (e.g. the former sender of the attachment) that the attachment has been replaced. Alternatively in such cases the reference can be deleted either manually or automatically by the sender or the sending system respectively.

The present invention can be implemented in various types of known E-mail systems. For example it can be implemented in a Lotus Notes system, whereby references similar to the known links in Lotus Notes are generated. Thereby the new references are not created manually. Instead the references are automatically generated in order to replace attachment files in E-mails, and can refer to all kind of documents.

With the use of the present invention the attachment of the E-mail stays always as close as possible to the receiver location. Changes to E-mail handling components on the sender's side and in the transmitting network are not necessary. The new concept of using attachment databases at the receiving side and the new attachment handling device suppress the storage and transmission of redundant data. This provides considerable savings of transmission cost, disk space, and mailing time. Thereby the present invention is most useful if E-mails with attachments are sent to multiple recipients. Since attachments are stored automatically in the server attachment database, they will be preserved even if the original E-mail is deleted erroneously.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows an E-mail system according to an embodiment of the present invention,

FIG. 2 is a flow diagram describing the operation of an attachment handling agent according to an embodiment of the present invention,

FIG. 3 shows the content of an E-mail with attachment according to an embodiment of the present invention,

FIG. 4 shows the content of an E-mail with document link according to an embodiment of the present invention,

FIG. 5 shows the content of a server attachment database according to an embodiment of the present invention,

FIG. 6 is a flow diagram describing the operation of an attachment copy agent according to an embodiment of the present invention.

### BEST MODE FOR CARRYING OUT THE INVENTION

An E-mail (electronic mail) according to the present invention is any electronic message send from one computer (or any other device suitable for sending such message) to another computer (or any other device suitable for receiving such message). These computers can be connected e.g. via local or global networks and/or via modems through telephone lines or by other means. For the desription of the present invention it is assumed that the E-mail is received by a system utilizing a ‘client/server-architecture’.

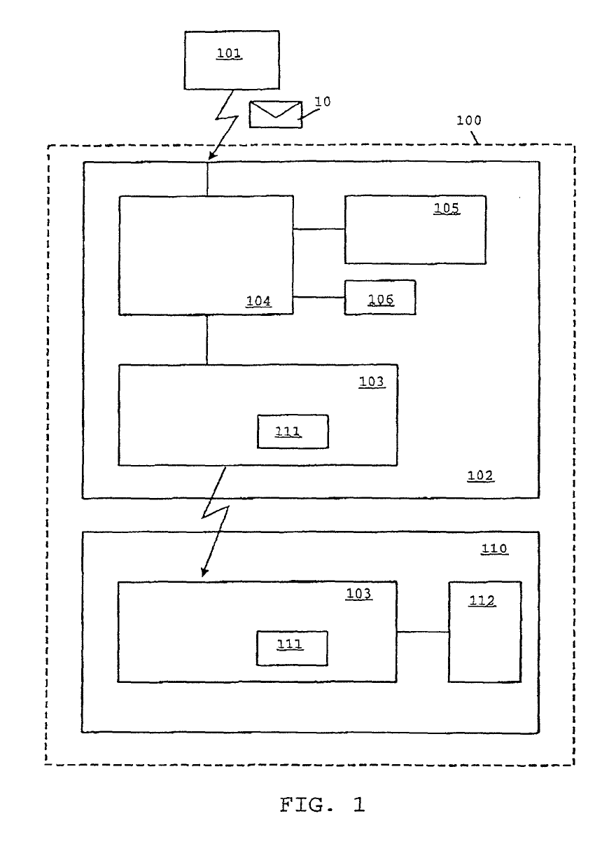

In FIG. 1 an E-mail system 100 according to an embodiment of the present invention is illustrated. Since for the present invention the receiving procedure is relevant, the sender 101 sending an E-mail 10 is merely shown rudimentary. Details of the sender 101 and any additional instances between the sender 101 and the receiving side, e.g. sending server, post offices etc. on the sending side are not shown.

The E-mail system 100 consists preferably of at least one receiving server 102 and at least one client 110. The receiving server 102 comprises client mail databases 103 for each client 110. However, only one client 110 and only one client mail database 103 in the receiving server 102 is shown in FIG. 1 for clarity reasons.

The receiving server 102, e.g. an AS/400® or System/390® or RS/6000® system from IBM®, is connectable, e.g. via wired or wireless data communication links, to the client's systems 110, which can be e.g. workstations, personal computers or portable computers. Furthermore it should be pointed out that not all parts of the receiving server 102 and the client system 110 are illustrated in FIG. 1.

On the receiving server 102 resides an attachment handling agent 104. The attachment handling agent 104 is preferably implemented as a software program, e.g. as integrated part of the mail server software implementing a certain functionality. Preferably the attachment handling agent 104 is constantly executed during operation of the receiving server 102, performing its functionality automatically each time an incoming E-mail 10 arrives at the receiving server 102. The attachment handling agent 104 is preferrably implemented such that it can be switched off temporary or permanently by e.g. the administrator of the receiving server 102.

Furthermore, according to the present invention a server attachment database 105 resides on the receiving server 102. Thereby the server attachment database 105 is connected or connectable to the attachment handling agent 104. In another embodiment of the present invention the server attachment database 105 may be e.g. residing on another physical machine, local to the receiving server 102, whereby the specific physical location of the server attachment database 105 is not relevant to the invention. It should be noted however, that the server attachment database 105 logically belongs to the receiving server 102.

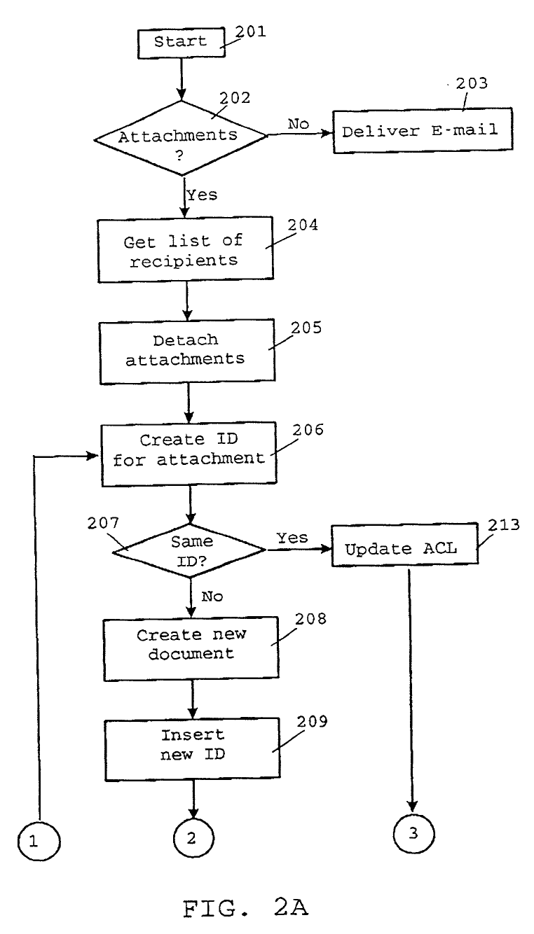

FIG. 2 is a flow diagram describing the operation of an attachment handling agent 104 according to an embodiment of the present invention. Each time an E-mail 10 arrives at the receiving server 102 the attachment handling agent 104 starts its operation in step 201 and checks the incoming E-mail 10 for attachments in step 202. If no attachments are present, the receiving server 102 continues to deliver the received E-mail 10 to the recipients in step 203, e.g. by putting the E-mail 10 into the clients mail databases 103 of the according recipients. If attachments are present in the received E-mail 10, the attachment handling agent 104 reads the list of recipients in step 204, e.g. a list of E-mail addresses.

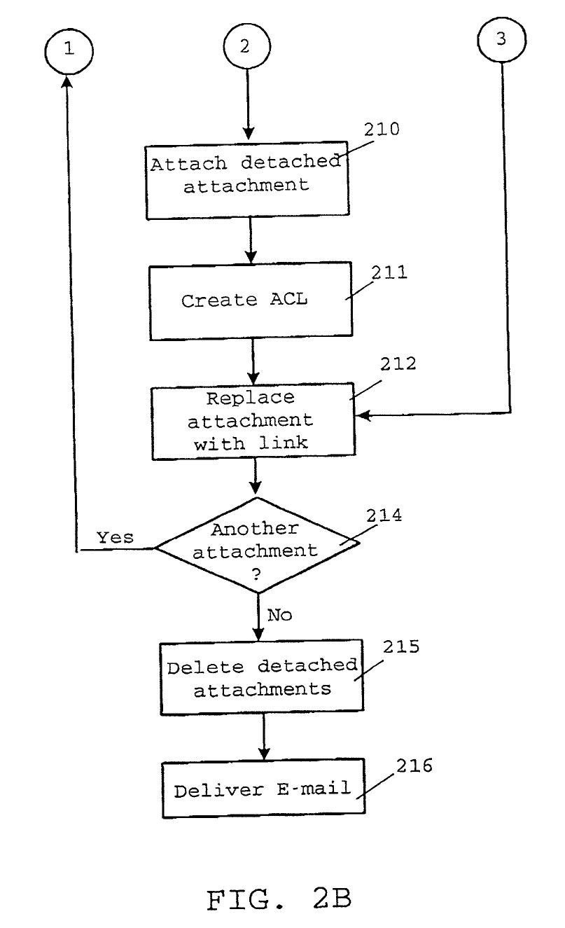

The content of an E-mail 10 comprising the body 310 if the E-mail and an attachment 300 is illustrated in FIG. 3.

Next in FIG. 2, the attachment handling agent 104 detaches all attached files 300 in step 205, preferably e.g. to the receiving server's hard disk 106 or into any other storing device accessable by the attachment handling agent 104, thereby generating copies of the attached files 300. After the attached file 300 has been detached, the attachment handling agent 104 creates an identification (attachment ID) for the attachment 300 in step 206. For this purpose the attachment handling agent 104 reads the name of the detached file 300 and the date and time, at which the detached file 300, e.g. a text document, has originally been created, e.g. by means of a text processor. Using file name and creation date and time, the attachment handling agent 104 generates the attachment ID for the attachment 300. The attachment ID may as well be generated using other data resulting from the attachment file which are usable to identify the attachment, e.g. size of attachment or electronic signature data. In the next step 207, the attachment handling agent 104 checks the server attachment database 105 for an existing server attachment database document with the same attachment ID. If such a document does not exist, that is if the attachment ID is new, the attachment handling agent 104 creates a new server attachment database document in the server attachment database 105 in step 208, e.g. by using an according standard command of the database system. Next the attachment handling agent 104 inserts the created attachment ID into the server attachment database document in step 209 and attaches the detached file 300 thereto in step 210. In a next step 211 the attachment handling agent 104 enables the recipients of the E-mail 10 to access the new server attachment database document. This can be done e.g. by creating an access control list (ACL) based on the list of recipients or by creating an according entry in an authorization database. Next, the attachment handling agent 104 replaces the attachment 300 in the E-mail 10 with a document link to the new server attachment database document in step 212.

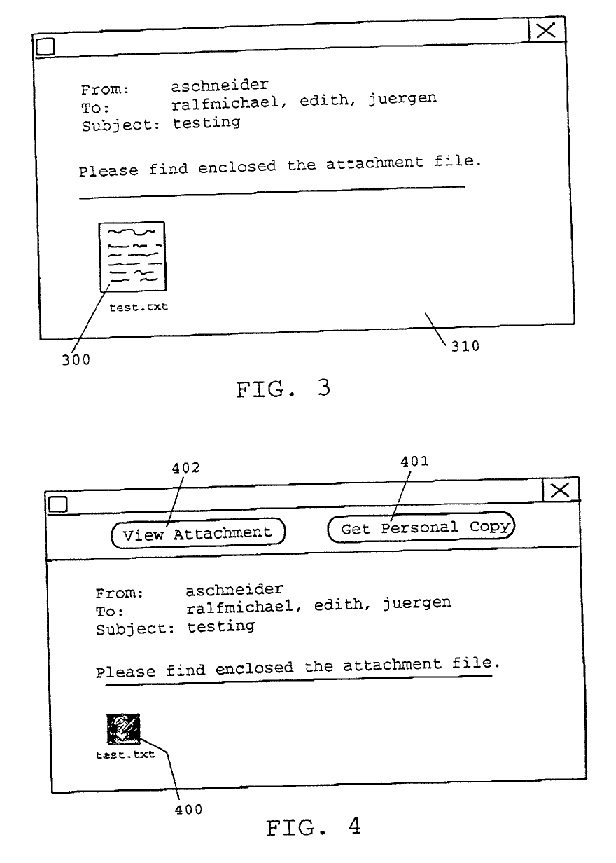

FIG. 4 illustrates an E-mail 10 comprising such a document link 400 instead of the attachment 300.

As illustrated in FIG. 2, in cases, where a server attachment database document with the same attachment ID exists, the attachment handling agent 104 updates the according ACL in step 213 and replaces the attachment 300 in the E-mail with a reference to the already existing server attachment database document in step 212. The reference can be a link 400, e.g. a link as used in hypertext documents, or any other suitable reference to the server attachment database document. In a preferred embodiment of the invention the link 400 is represented by an icon that gives the user direct access from the E-mail to the attachment 300. Preferably the replacing step takes place only if a check of the previous steps (not shown) has been carried out successful. The procedure described above is carried out for each attachment 300 (see step 214). If all attachments 300 have been processed, the attachment handling agent 104 deletes the files which have been detached in step 215, e.g. from the server's hard disk 106. Finaly in step 216, the attachment handling agent 104 puts the resulting E-mail 10 into all of the recipient's mail databases 103 on the receiving server 102, to which the attachment handling agent 104 is connected.

FIG. 5 shows the content of a server attachment database 105 according to an embodiment of the present invention. The server attachment database 105 comprises server attachment database documents, whereby each such document 500 preferably consists of the attachment ID 501, which was created in step 206 from the name 510 and the creation date 511 and creation time 512 of the detached file 300, and the file 300 detached in step 205 and subsequently attached to the server attachment database document 500 in step 210.

In a preferred embodiment of the present invention the check for an existing server attachment database document 500 can be modified to search for the filename 510 first and then compare the date 511 and time 512 of all hits with the according data from the new attachment 300. Step 212 in FIG. 2 is then be modified e.g. such that the attachment 300 can be replaced with multiple links 400 to all server attachment database documents 500 containing the same filename 510 in the attachment ID 501, e.g. in an chronological order. This embodiment of the invention is advantageous for handling multiple versions of one attachment.

The present invention may be preferrably applicable to systems, where clients work with a replication of the client mail database 103, since such clients will preferably receive E-mails without attachment 300, which reduces replication time considerably. Using an E-mail system 100 utilizing the present invention the client does not need to have a permanent local copy of the attachment 300 in order to read it. In case, the client wants to read an attachment 300, the attachment 300 is merely loaded into the memory of the client's system 110 as a volatile ‘read only’ copy. This can be done e.g. by a view attachment agent (not shown), preferably implemented in the client mail database system 103, with access to the server attachment database 105.

In a preferred embodiment of the present invention a further agent, called attachment copy agent 111 is introduced. The attachment copy agent 111 is preferably implemented as a software program related to the client, e.g. as part of the client mail database software 103 implementing a certain functionality, namely to provide personal copies of the attachments 300 to the recipient.

Preferably the attachment copy agent 111 is invoked by the recipient manually via an action button 401 implemented in it's E-mail software, e.g. ‘Get personal copy’. This can be done e.g. when the recipient views the received E-mail from its client mail database 103 and discovers one or more links 400 therein. Alternatively, e.g. via a user defined setting, the attachment copy agent 111 performs its functionality automatically for all links 400 for each incoming E-mail (automatic retrieval of all attachments). The automatic retrieval is preferably executed during replication of the client mail database 103.

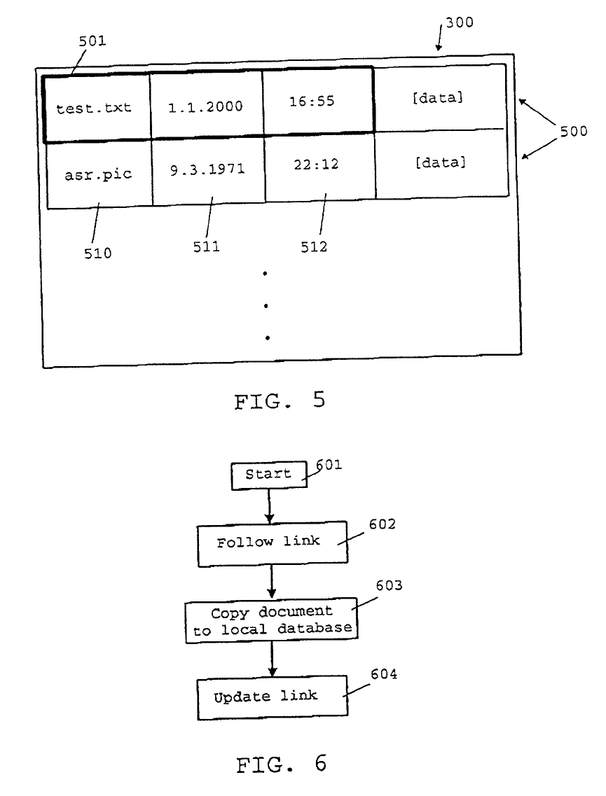

FIG. 6 illustrates the operation of the attachment copy agent 111 according to an embodiment of the present invention. Each time this procedures starts in step 601, that is the attachment copy agent 111 is executed, the agent 111 follows the selected link 400 (or all links when executed automatically) to the according server attachment database document 500 in step 602. Next the attachment copy agent 111 copies this document 500 from the server attachment database 105 to a local client attachment database 112 in step 603. The client attachment database 112 is preferably implemented as part of the client mail database 103. In another embodiment the client attachment database 112 is implemented as a seperate database on the client's system 110. Finaly the attachment copy agent 111 updates the followed links such that they point to the according client attachment database documents in step 604.

In an embodiment of the present invention the attachment copy agent 111 additionally comprises the functionality provided by the view attachment agent as described above, e.g. the recipient only uses the attachment copy agent 111 and may decide whether to only read the attachment 300 from the server attachment database 105 or to copy the attachment to the client attachment database 112 it's system 110, e.g. by pressing according action buttons 401, 402 provided by the E-mail software.

In a preferred embodiment of the present invention the attachments 300 will be stored in the server attachment database 105 for a certain time which can be defined by the E-mail system's administrator and will be deleted automatically if this time is exceeded (database maintenance). For the client attachment database 112, the user of the client system 110 can preferably define his own storage time. If this time is exceeded, a list of expired attachment will be shown and the user will be asked whether they can be deleted.

In the following an E-mail system 100 utilizing the present invention and a prior art E-mail system are compared with each other. For this reason it is assumed, that both sender and recipient work with a replication of the mail database which is e.g. the normal Lotus Notes setup especially when working with a portable computer. A client attachment database is not used.

If in a prior art E-mail system the sender sends an E-mail with attachment to the recipient, the attachment is stored in the sender's mail database on the sending server and in its local replication. The E-mail is transmitted to the recipient's server together with the attachment and stored in the recipient's mail database on the server and in its local replication. If the recipient replies to this E-mail without manually deleting the attachment, e.g. using a ‘reply with history’ function to include the original message in the new message, the E-mail with the attachment is stored a second time in the recipient's mail database and its local replication and is send back to the sender. The reply with the attachment is also stored again in the sender's mail database and its local replication. This means that one attachment is stored two times at the sending location and two times at the receiving location with each transmission. If the original E-mail with attachment is sent to multiple recipients, the number of stored copies is multiplied by the number of recipients, even if all recipients reside on the same server. The total disk space needed (sender and receiver) is calculated as

2(1+n)m*size of attachments

wherein n denominates the number of recipients and m denominates the number of transmissions.

If a sender 101 sends an E-mail 10 with attachment 300 to a recipient which uses an E-mail system 100 utilizing an embodiment of the present invention, the attachment 300 is stored in the sender's mail database on the sending server and on its local replication (not shown in FIG. 1). The E-mail 10 is transmitted to the recipient's server 102 together with the attachment 300. In the receiving server 102 the attachment handling agent 104 detaches the attachment 300 to the server attachment database 105 and replaces the attachment 300 in the E-mail by a document link 400 to the server attachment database document 300 in the server attachment database 105. The E-mail comprising the link 400 is stored in the recipients mail database 103 and its local replication. Therefore, only one copy of the attachment is stored at the recipient's location. If multiple recipients reside on the same server 102, all recipients receive an E-mail with a link 400 to the same attachment document copy 500. Thus the number of stored copies is only multiplied by the number of receiving server attachment databases 105. If the recipient replies, e.g. using a ‘reply with history’ function, the E-mail comprising the link 400 is sent back to the sender and unnecessary transmissions of the attachment 300 and repeated storing of copies of the attachment is prevented automatically. The total disk space needed (sender and receiver) is calculated as

(2+x)*size of attachments

wherein x denominates the number of server attachment databases.

With the number of transmission between the sender and the receiver increasing, the advantage of the attachment handling system according to the present invention is growing rapidly.

The number of server attachment databases 105 can be optimized if multiple receiving servers 102, e.g. which are located close to each other, share the same server attachment database 105.

The present invention can be implemented e.g. in existing E-mail systems, e.g. Lotus Notes. However it should be noted that in order to carry out the present invention the system utilizing the present invention does not need to be able to send E-mails. The present invention may as well be implemented in ‘receive only’ systems.

The present invention can be realized in hardware, software, or a combination of hardware and software. The invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. Method for handling E-mail messages in a communication system comprising one or several intermediate receivers (102), each serving at least one recipient, the method comprising:
detaching, in the intermediate receiver (102), any attachment (300) in an E-mail message and storing the attachment, replacing each attachment in the E-mail message (10) with a reference (400) to the stored attachment, and
forwarding the E-mail message (10) with the reference (400) from the intermediate receiver (102) to the recipient specified in the E-mail message (10).

2. The method of claim 1, wherein the detaching comprises:
copying the at least one attachment (300) to an attachment database (105) accessible to all intermediate receivers (102) at a receiving side (100).

3. The method of claim 1, further comprising:
defining access conditions such that the stored attachment (300) is accessable for each recipient of the according reference (400).

4. The method of claim 1, wherein the attachment is replaced with multiple references to multiple versions of the attachment.

5. The method of claim 1, further comprising:
upon an according request of the recipient, transferring the stored attachment to the recipient.

6. System for handling E-mail messages in a communication system, comprising one or more intermediate receivers (102), each serving at least one recipient, the intermediate receiver (102) comprising an attachment handling device (104) adapted for
detaching any attachment (300) in an E-mail message (10) and storing the attachment (300),
replacing each attachment (300) in the E-mail message (10) with a reference (400) to the stored attachment, and
forwarding the E-mail message (10) with the reference (400) from the intermediate receiver (102) to the recipient specified in the E-mail message (10).

7. The system of claim 6, further comprising a first attachment database (105) accessable to all intermediate receivers (102) at a receiving side (100) and connectable to the attachment handling device (104).

8. The system of claim 7, wherein the first attachment database (105) is located at the intermediate receiver (102).

9. The system of claim 7, further comprising for at least one of the recipients an attachment copy device (111) adapted for transferring the stored attachment from the first attachment database (105) to the recipient.

10. The system of claim 7, further comprising a second attachment database (112) connectable to the attachment copy device (111).

11. The system of claim 6, wherein the intermediate receiver (102) is a server in a client-server architecture, serving at least one recipient's client (110).

12. The system of claim 10, wherein the second attachment database (112) is located at the recipient's client (110).

13. The system of claim 11, wherein the second attachment database (112) is located at the recipient's client (110).

14. Computer program product directly loadable into the internal memory of a computer, comprising software code portions for performing the steps of claim 1 when said product is run on a computer.

15. Computer system comprising an internal memory, wherein the computer program product of claim 14 is loaded, and an execution environment for executing a method of handling E-mail messages in a communication system comprising one or several intermediate receivers (102), each serving at least one recipient, the method comprising:
detaching, in the intermediate receiver (102), any attachment (300) in an E-mail message and storing the attachment,
replacing each attachment in the E-mail message (10) with a reference (400) to the stored attachment, and
forwarding the E-mail message (10) with the reference (400) from the intermediate receiver (102) to the recipient specified in the E-mail message (10).
